(19) United States
(12) Patent Application Publication
(10) Pub. No.: US 2005/0214719 A1
(43) Pub. Date: Sep. 29, 2005

(54) Method for extracting a tooth

(75) Inventor: Gabor Hermann, Tuttlingen (DE)

Correspondence Address: Lipsitz & McAllister, LLC, 755 MAIN STREET, MONROE, CT, 06468, US

(73) Assignee: AESCULAP AG & Co. KG, Tuttlingen (DE)

(21) Appl. No.: 10/807,910

(22) Filed: Mar. 23, 2004

(51) Int. Cl. A61C 5/00; A61C 3/14

(52) U.S. Cl. 433/215; 433/159

(57) ABSTRACT

The invention relates to a method of extracting a tooth from the jawbone of a human being or an animal with a tooth extraction instrument, the tooth extraction instrument being able to be brought from an applying position in which the tooth extraction instrument may be applied to the tooth to be extracted into an extracting position in which the tooth extraction instrument is secured to the tooth to be extracted, comprising the steps: applying and grasping the tooth extraction instrument assuming the approaching position to the tooth to be extracted, fixing the tooth extraction instrument on the tooth to be extracted by transferring the tooth extraction instrument from the applying position to the extracting position, and performing extracting movements with the tooth extraction instrument for levering out the tooth to be extracted.

### BACKGROUND OF THE INVENTION

The present invention relates to a method of extracting a tooth from the jawbone of a human being or an animal with a tooth extraction instrument.

Teeth are usually removed with the aid of a tooth extraction instrument, for example, with tooth extraction forceps. Such forceps are described by way of example in DE 100 44 939 A1, which is incorporated in its entirety by this reference in the present application. A tooth can be grasped between two contacting elements with a tooth extraction forceps described in the aforementioned publication. In order to hold the tooth in this extracting position, the grip elements of the instrument must be permanently held under tension manually during the extracting procedure. Otherwise the contacting elements may slide off the tooth to be extracted. This method is disadvantageous in that an operator must apply not only forces for levering the tooth out of the jawbone, but also a holding or clamping force in order to securely hold or clamp the tooth between the contacting elements of the tooth extraction forceps. This is not easy to carry out especially when the tooth to be extracted is seated in the jawbone in a position in which the operator is unable to hold the tooth extraction forceps in a manner which is ergonomically conceived therefor. In the worst case this may cause a cramp in the hand or wrist of the operator, with the result that he slips off the tooth to be extracted with the tooth extraction forceps. During the levering the pressure on the tooth is additionally increased. This may cause the crown to be destroyed. The tooth socket is damaged by the strong levering movements, which may result in traumatic secondary pain for the patient.

A method of extracting a tooth out of a jawbone is, therefore, required, which in a simple and safe way prevents the operator from slipping off the tooth to be extracted with the tooth extraction forceps. It would also be desirable for the operator not to have to apply any additional forces during the extracting of the tooth in order to hold the tooth extraction instrument on the tooth to be extracted.

### OBJECTS

An object of the invention is to provide an improved method of extracting a tooth from a jawbone.

A further object of this invention is to indicate an improved tooth extracting method, which facilitates the extracting of a tooth for the operator and avoids additional holding forces to be applied by the operator for holding the tooth on a tooth extraction instrument.

### BRIEF DESCRIPTION OF THE DRAWINGS

FIG. 1 shows a partly broken open plan view of tooth extraction forceps in an applying position.

FIG. 1a shows an enlargement of section A in FIG. 1.

FIG. 2 shows a view of the instrument from FIG. 1 assuming a dead center position of the joint.

FIG. 2a shows an enlargement of section B in FIG. 2.

FIG. 3 shows a view of the instrument from FIG. 1 assuming an extracting position.

FIG. 3a shows an enlargement of section C in FIG. 3.

### SUMMARY OF THE INVENTION

The present invention indicates a method of extracting a tooth from the jawbone of a human being or an animal with a tooth extraction instrument, the tooth extraction instrument being able to be brought from an applying position in which the tooth extraction instrument may be applied to the tooth to be extracted into an extracting position in which the tooth extraction instrument is secured to the tooth to be extracted, comprising the steps:
applying and grasping the tooth extraction instrument assuming the approaching position to the tooth to be extracted,
fixing the tooth extraction instrument on the tooth to be extracted by transferring the tooth extraction instrument from the applying position to the extracting position, and
performing extracting movements with the tooth extraction instrument for gently levering out the tooth to be extracted.

Owing to the tooth extraction instrument being fixed on the tooth to be extracted, the operator can focus his entire concentration on the gentle levering out of the tooth by moving the instrument. The tooth extraction instrument independently remains fixed on the tooth in the extracting position without any additional application of force by the operator. With light sideways movements the operator can thus extract the tooth almost vertically with feeling without any excessive levering. This has a saving effect on the tooth socket and the jawbone.

In a preferred variant of the inventive method, tooth extraction forceps are used as a tooth extraction instrument. The tooth extraction forceps comprise two contacting elements for application to the tooth, the contacting elements being adjustable in their mutual spacing in a clamping direction by a handling device in such a manner that the contacting elements may be brought from the applying position into the extracting position.

In order to further facilitate the fixing of the tooth extraction instrument on the tooth, the spacing of the contacting elements from each other can be adapted in rough approximation to the diameter of the tooth to be extracted prior to applying the tooth extraction instrument to the tooth to be extracted. For example, the adapting of the spacing of the contacting elements from each other can be carried out in the extracting position, with a minimum spacing of the contacting elements then being set, or in the applying position, with a maximum spacing of the contacting elements from each other then being set.

With a tooth extraction instrument, for example, with fixedly predetermined spacings of the contacting elements in the applying position and in the extracting position, it is expedient, prior to applying the tooth extraction instrument to the tooth to be extracted, for the maximum spacing of the contacting elements in the applying position to be adjusted such that at most it is 25% greater than the diameter of the tooth to be extracted. Thus, for example, movements of the handling device for transferring the tooth extraction instrument from the applying position into the extracting position can be minimized.

Provision may be made in a preferred variant of the method for the maximum spacing of the contacting elements in the applying position, prior to applying the tooth extraction instrument to the tooth to extracted, to be adjusted such that it is approximately 10% to 25% greater than the diameter of the tooth to be extracted. This can, for example, be achieved by the operator estimating the tooth diameter.

It is expedient for a minimum spacing of the contacting elements in the extracting position to be adjusted prior to applying the tooth extraction instrument to the tooth to be extracted, such that it is smaller than the diameter of the tooth, and, after adjusting the minimum spacing of the contacting elements, for the tooth extraction forceps to be transferred to the applying position. This procedure makes it possible to adapt the spacing of the contacting elements in an optimum way to the diameter of the tooth to be extracted. Thus, the spacing of the contacting elements from each other in the extracting position is first adjusted, and the instrument is then transferred to the applying position in which the tooth to be extracted can be introduced between the two contacting elements. When the tooth extraction instrument is then transferred to the extracting position again, the tooth to be extracted is held securely between the two contacting elements.

A particularly secure hold of the tooth to be extracted on the tooth extraction instrument in the extracting position is obtained when the minimum spacing of the contacting elements is adjusted such that it corresponds approximately to 0.8 to 0.9 times the diameter of the tooth to be extracted. In particular, this can be the minimum spacing in the extracting position.

To enable adjustment of the minimum spacing of the contacting elements in the extracting position with particular accuracy, it is advantageous for the tooth extraction instrument to be brought up close to the tooth in the extracting position for adjustment of the minimum spacing of the contacting elements. The operator can then immediately recognize whether the spacing between the contacting elements is small enough for the tooth to be extracted to be held securely between the contacting elements in the extracting position after applying the tooth extraction instrument to the tooth to be extracted.

A particularly simple design of the tooth extraction instrument and a particularly advantageous handling thereof are obtained when the two contacting elements can be swivelled about a swivel axis relative to each other, and when the two contacting elements are swivelled about the swivel axis relative to each other for fixing the tooth extraction instrument on the tooth.

To make the construction of the tooth extraction instrument particularly simple, it may be advantageous for the one contacting element to be supported via an articulated knee lever on the other contacting element, with the articulated knee lever comprising two parts mounted on each other for swivel movement about a joint swivel axis, and with one of the two contacting elements and one of the two parts of the knee lever carrying grip elements via which they may be swivelled relative to each other.

A particularly good hold of the tooth extraction instrument on the tooth to be extracted is obtained when a distance of the joint swivel axis from the grip element of the other contacting element is smaller in the extracting position than in the applying position.

One can make sure in a particularly simple way that the tooth extraction instrument is held in the extracting position on the tooth to be extracted by the articulated knee lever being moved, by swivelling of the two grip elements relative to each other, during transition of the tooth extraction instrument from the applying position to the extracting position, over a dead center position of the joint in which a first supporting point associated with the one contacting element, a second supporting point of the knee lever associated with the other contacting element, and the joint swivel axis lie on one line. Owing to this construction, an independent transition of the instrument from the extracting position to the applying position is only possible by applying an appropriate releasing force, as the dead center position of the joint forms a kind of energetic barrier for the tooth extraction instrument which must be overcome in order to release the tooth extraction instrument from the tooth.

In accordance with a preferred form of the method, the handling device is acted upon with an actuating force acting substantially parallel or opposite to the clamping direction, in order to overcome the dead center position of the joint.

It is advantageous for a supporting point of the knee lever to be adjustable at one end. This makes it possible to individually adapt a dead center position of the joint of the instrument as a function of the diameter of the tooth to be extracted.

In accordance with a preferred variant of the method, a maximum spacing of the contacting elements in the applying position and/or a minimum spacing of the contacting elements in the extracting position is set by adjusting the supporting point of the knee lever. In this way, for example, an adjustment of the spacing of the contacting elements can be carried out at a proximal end of the instrument by an operator. This makes it possible to bring the contacting elements of the tooth extraction instrument up close to the tooth to be extracted and to set in a simple way the spacing of the two contacting elements from each other in a desired manner.

It is particularly expedient for the supporting point of the knee lever to be defined by a swivel mounting of the knee lever on a slide sleeve and for the supporting point to be adjusted by displacing the slide sleeve. In particular, the slide sleeve may form part of the grip element. The supporting point of the knee lever can be adjusted in a simple way by the slide sleeve.

The slide sleeve is preferably displaced by means of a spindle drive associated with the slide sleeve. The spindle drive may, for example, be arranged on a grip element or integrated therein.

It is particularly advantageous for the tooth extraction instrument to comprise an energy accumulator, and for the contacting elements to be movable away from each other against the action of the energy accumulator. For example, an adjustment of the minimum spacing of the contacting elements in the extracting position and/or of the maximum spacing in the applying position, which is not optimal, can thereby be evened out. In particular, one can in this way prevent the tooth to be extracted from being crushed between the two contacting elements and thereby destroyed if the minimum spacing of the contacting elements in the extracting position was pre-adjusted such that it was too small. In this way, so to speak, the pressure exerted by the contacting elements on the tooth can be attenuated.

It may also be expedient for a supporting point of the knee lever to be coupled with the energy accumulator in such a way that the supporting point is movable against the action of the energy accumulator. It is thus possible for a spacing of the contacting elements to be increased against the action of the energy accumulator. In this way, destruction of the tooth by too high clamping forces exerted by the two contacting elements is prevented.

The energy accumulator is preferably arranged in the area between the swivel axis and at least one of the two contacting elements. The energy accumulator can then be acted upon with a force opposite a clamping direction of the two contacting elements in order to enlarge the spacing of the two contacting elements from each other, whereby destruction of the tooth to be extracted can be avoided.

A particularly simple construction of the tooth extraction instrument is obtained when the tooth extraction instrument comprises two clamping arms which include the contacting elements, and when at least one of the two clamping arms forms the energy accumulator by way of its inherent elasticity. If at least one of the two clamping arms possesses a certain basic elasticity, this may be sufficient to prevent destruction of the tooth to be extracted as a result of an adjustment of the minimum spacing of the contacting elements in the extracting position which is not optimal.

Furthermore, it may be expedient for the energy accumulator to be formed by a spring supported on the grip element. In particular, when one of the supporting points of the knee lever is supported on the spring, the knee lever can be moved against the spring supported on the grip element, whereby the spacing between the contacting elements can be enlarged against the action of the energy accumulator.

It is particularly advantageous for the handling device to comprise a stop, and for the handling device to be actuated in such a manner during transfer of the tooth extraction instrument from the applying position to the extracting position until at least part of the handling device strikes the stop. A range of movement of the handling device is limited at least on one side by the stop, so that a desired extracting position can be predetermined.

The construction of the tooth extraction instrument and its use become particularly simple when the stop is arranged on the joint part of the articulated knee lever, which connects the two grip portions of the tooth extraction instrument.

For transfer from the applying position to the extracting position, it is advantageous for the handling device to be actuated in such a manner that the articulated knee lever passes through the dead center position of the joint before the at least one part of the handling device strikes the stop in the extracting position. In this way, the dead center position of the joint acts as a kind of barrier which has to be overcome in order to transfer the tooth extraction instrument from the extracting position to the applying position.

In a simple way, contacting elements can be arranged in a desired manner on the tooth extraction instrument when this comprises at least one holder for one of the two contacting elements, with the at least one holder carrying the said one of the two contacting elements.

It is expedient for at least one of the two contacting elements to be mounted on the holder for rotation about an axis of rotation arranged transversely to the clamping direction. Thus, for example, with tooth extraction forceps comprising two contacting elements pivotable relative to each other, sides of the contacting elements which face each other can be moved parallel to each other.

A parallel orientation of the two contacting elements is obtainable when the swivel axis extends parallel to the axis of rotation of the at least one rotatable contacting element.

Furthermore, it may be expedient for at least one of the contacting elements to comprise two contacting surfaces arranged on opposite sides of the axis of rotation and constructed so as to project in such a manner that upon application to the tooth, they place themselves substantially in the form of a point or substantially parallel to the axis of rotation in the form of a line on the tooth.

The contacting element with the two adjacent contacting surfaces preferably comprises in cross section two convex sections separated from each other by a recess.

It is favorable for the recess to be of arc-shaped construction and to pass tangentially into the adjacent arc-shaped convex sections.

For a number of teeth to be extracted, it is particularly advantageous for the contacting surfaces to extend in the direction of the axis of rotation parallel thereto.

With other tooth shapes it may, however, be advantageous for the contacting surfaces to be inclined in the direction of the axis of rotation slightly away from the axis of rotation towards the free end of the contacting element.

Furthermore, it may be advantageous for both contacting elements to be mounted on their holders for rotation about parallel axes of rotation and to comprise adjacent contacting surfaces which can be placed in the form of a point or in the form of a line on the tooth.

With yet again different tooth shapes, it may be desirable for the second contacting element to comprise a single contacting surface which is constructed so as to project in such a manner that upon application to the tooth, it places itself substantially in the form of a point or substantially parallel to the axis of rotation of the first contacting element in the form of a line on the tooth.

To enable fixing of the tooth extraction instrument in an optimal way on the tooth to be extracted, a contacting surface of at least one of the two contacting elements can have a shape adapted to the tooth.

In order to carry out the method in an optimized way, it may be advantageous for one contacting element or the contacting elements to be mounted in the holder so as to be exchangeable. Depending on the shape and size of the tooth, contacting elements correspondingly adapted thereto can then be selected or also specially made for a certain tooth. Thus, destruction of the tooth to be extracted as a result of tensions occurring at the tooth during the fixing of the tooth extraction instrument in the extracting position can be minimized or even completely reduced.

Furthermore, it is expedient for the contacting element or contacting elements to be selected in accordance with the shape of the tooth to be extracted.

In order for the contacting elements not to be turned in an undefined manner in their holder, it is advantageous for contacting element stops to be provided for limiting the rotational movement of the contacting element or contacting elements.

To improve holding of the tooth extraction instrument on the tooth to be extracted, the contacting surfaces may be roughened.

Furthermore, it is advantageous for the contacting surfaces to be coated with diamond dust. Teeth to be extracted can thus be grasped and held particularly securely with the tooth extraction instrument.

### DETAILED DESCRIPTION OF THE INVENTION

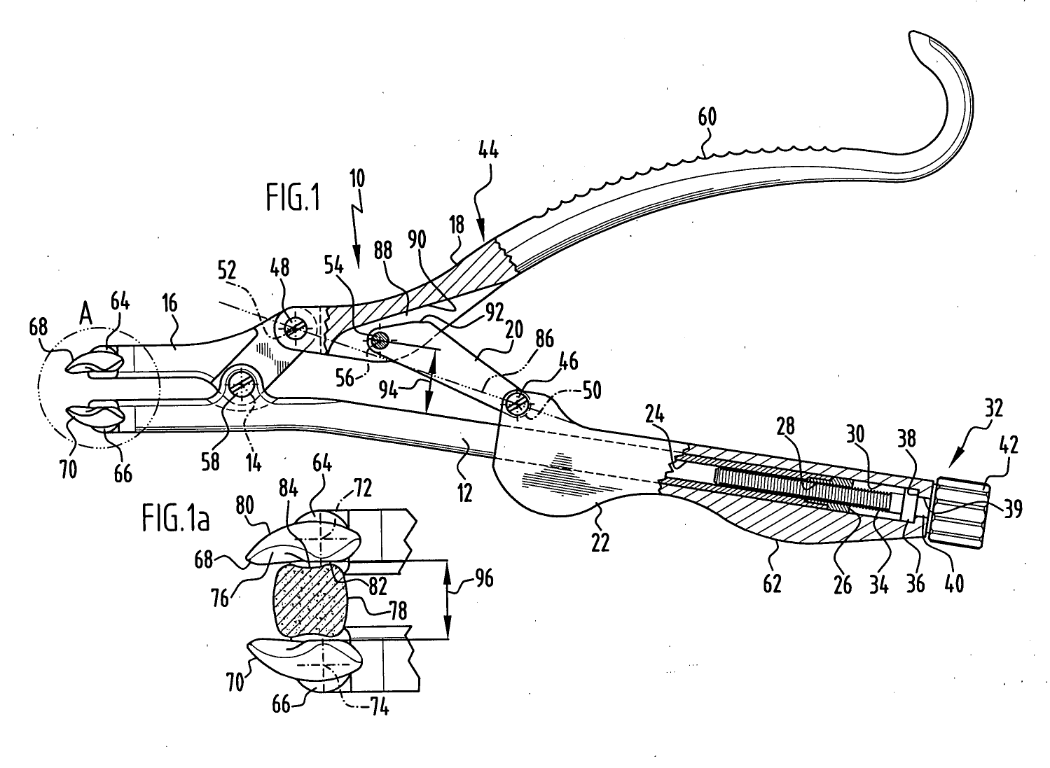

Tooth extraction forceps designated in their entirety by the reference numeral 10, which comprise a first, substantially straight-lined swivel lever 12, which is connected to a second swivel lever 16 for swivel movement about a swivel axis 14, are shown in FIGS. 1 to 3. The second swivel lever 16 is, however, substantially shorter than the first swivel lever 12 and articulatedly connected to a longer swivel grip 18. A first end of a connecting lever 20, whose other end is supported on a slide grip 22 surrounding the first swivel lever 12 at the free end thereof, articulatedly engages the swivel grip 18.

The swivel lever 12 is essentially in the form of an elongated cylindrical rod which is slightly bent adjacent to the connection to the swivel lever 16 and is provided with a coaxial blind hole bore 24 starting from its free end. Inserted into the open end of the blind hole bore 24 is a threaded sleeve 26, which comprises a continuous internal thread 28 which is somewhat smaller in diameter than the diameter of the blind hole bore 24. The slide grip 22 which is ergonomically shaped on the outside is provided on the inside with a blind hole bore 30 corresponding to the rod-shaped swivel lever 12, so that the slide grip 22 can be displaced on the swivel lever 12 in the longitudinal direction thereof.

To be able to carry out displacement of the slide grip 22 in a defined manner, an adjusting mechanism 32 is provided, which essentially comprises a threaded spindle 34 whose external thread corresponds to the internal thread 28 of the threaded sleeve 26. At its end pointing away from the swivel lever 12, the threaded spindle 34 is of thread-free design and strikes the bottom of the blind hole bore 30 with a ring-shaped flange 36. The bottom 38 is provided with a through bore 39 whose diameter is somewhat smaller than the diameter of the blind hole bore 30, so that an end 40 protruding from the flange 36 can extend through the bottom 38 and be non-rotationally connected to a rotary knob 42. By virtue of this design, turning of the rotary knob 42 can bring about rotation of the threaded spindle 34, which is rotatable relative to the slide grip 22, but is not axially displaceable relative to the latter. A rotation of the threaded spindle does, however, cause its body to be axially moved relative to the threaded sleeve 26, which, as a whole, results in an axial displacement of the entire slide grip 22 relative to the swivel lever 12.

The swivel grip 18 and the connecting lever 20 together form a two-part, articulated knee lever 44, by means of which the swivel lever 16 is supported on the slide grip 22 and hence on the swivel lever 12. When the swivel grip 18 is swivelled towards the swivel lever 12, the swivel lever 12 and the swivel lever 16 are swivelled towards each other in the area of their free ends, and the respective position of the two swivel levers 12 and 16 relative to each other, i.e., in particular, their spacing, is adjustable by displacement of the slide grip 22 in the above-described manner by means of the adjusting mechanism 32.

The knee lever 44 is connected to the slide sleeve 22 and to the swivel lever 16 by a joint screw 46 and 48, respectively, whose longitudinal axes simultaneously define joint axes 50 and 52, respectively. On the one hand, the swivel grip 18 can be swivelled relative to the swivel lever 16 about the joint axis 52 and, on the other hand, the connecting lever 20 can be swivelled about the joint axis 50 relative to the slide grip 22. The two parts of the knee lever 44, namely a short section of the swivel grip 18 and the connecting lever 20, are mounted by means of a joint pin 54 for swivel movement relative to each other about a joint swivel axis 56 formed by the axis of symmetry of the joint pin 54. A direct swivel mounting of the swivel lever 16 on the swivel lever 12 is achieved by a further joint screw 58 whose longitudinal axis defines the swivel axis 14. The joint axes 50 and 52 as well as the joint swivel axis 56 and the swivel axis 14 are all aligned parallel to one another.

Grip elements of the tooth extraction forceps 10 are formed by a proximal section 60 of the swivel grip 18 and by the outer surface 63 of the slide grip 22. A handling device of the tooth extraction forceps 10 essentially comprises the swivel grip 18 and the slide grip 22 mounted on the swivel lever 12.

At each of the distal ends 64 and 66 of the swivel levers 16 and 12, a stop element in the form of a clamping jaw 68 and 70, respectively, is mounted in a holder provided therefor, not described in greater detail, for rotational movement about an axis of rotation 72 and 74, respectively. The axes of rotation 72 and 74 extend parallel to the swivel axis 14. The two clamping jaws 68 and 70 are constructed in mirror-symmetrical relation to each other.

Therefore, only the clamping jaw 68 will be described in greater detail hereinbelow. It comprises a contacting surface 76 for placement on a tooth 78, with an outer side 80 pointing away from the contacting surface 76 being convexly curved. The contacting surface 76 comprises from the distal end of the clamping jaw 68 a concave section and adjoining this a convex section 82 which is shaped so as to correspond substantially to a concave recess 84 of the tooth 78. As a whole, the contacting surface 76 is curved and shaped in such a way as to enable contact with the tooth 78 over as large an area as possible.

A first variant of the inventive method of extracting a tooth will be explained in greater detail in conjunction with FIGS. 1 to 3.

The tooth extraction forceps are shown in an applying position in FIG. 1. This means that the contacting surfaces 76 of the clamping jaws 68 and 70 are spaced so far apart that without any contact they can receive a tooth 78 between them without touching it. To this end, the slide grip 22 is moved relative to the swivel lever 12 by the adjusting mechanism 32 such that a spacing between the contacting surfaces 76 of the clamping jaws 68 and 70 is approximately between 10% and 25% greater than the diameter of the tooth 78. In the applying position, the joint swivel axis 56 takes up a position in which it is spaced at a greater distance 94 from the swivel lever 12 than a connecting line 86 of the two joint axes 50 and 52. Furthermore, there is a gap 88 between an inner side 90 of the swivel grip 18 oriented in the direction towards the swivel lever 12 and an edge 92 of the connecting member 20 pointing in the direction towards the inner side 90.

To fix the tooth extraction forceps 10 on the tooth 78, the distance 96 between the two clamping jaws 68 and 70 in the opened applying position of the tooth extraction forceps 10 shown in FIG. 1 is adjusted by turning the rotary knob 42 such that it is approximately 10% to 25% larger than the diameter of the tooth 78. The tooth extraction forceps 10 are then brought up to the tooth 78 such that the tooth is introduced at both sides between the contacting surfaces 76 of the clamping jaws 68 and 70, as shown in FIG. 1a.

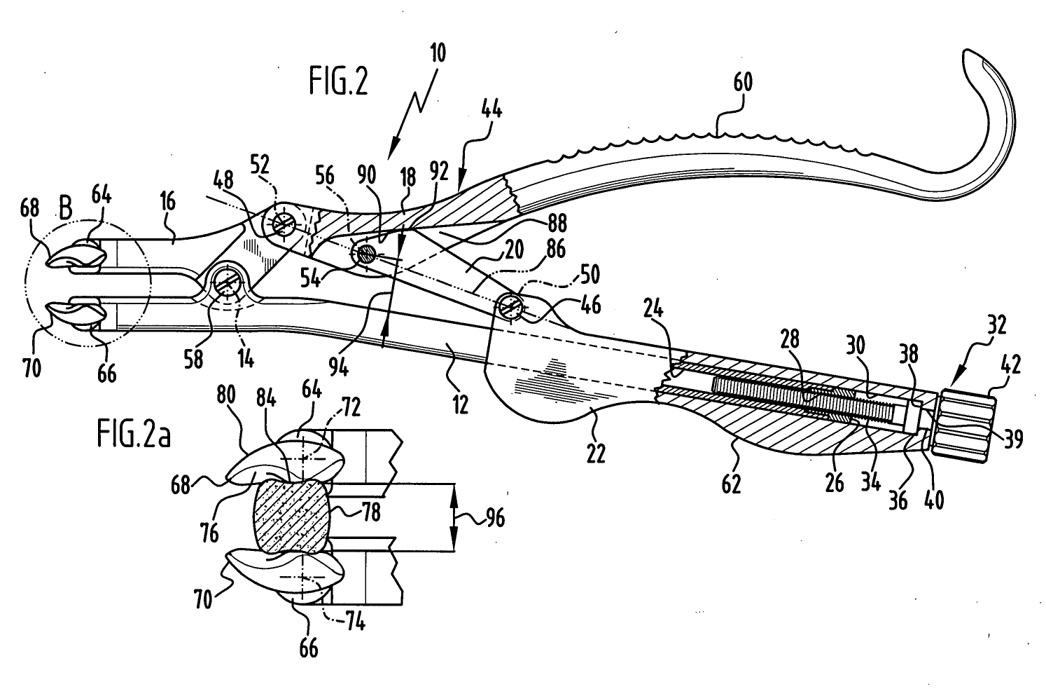

To secure the tooth extraction forceps 10 on the tooth 78, the swivel grip 18 is now moved in the direction towards the swivel lever 12. The joint swivel axis 56 thereby passes through the position shown in FIGS. 2 and 2a, the so-called dead center position of the joint. Herein the two joint axes 50 and 52 and the joint swivel axis 56 all lie on the connecting line 86. This is the position in which the two clamping jaws 68 and 70 are spaced at the smallest distance 96 from each other.

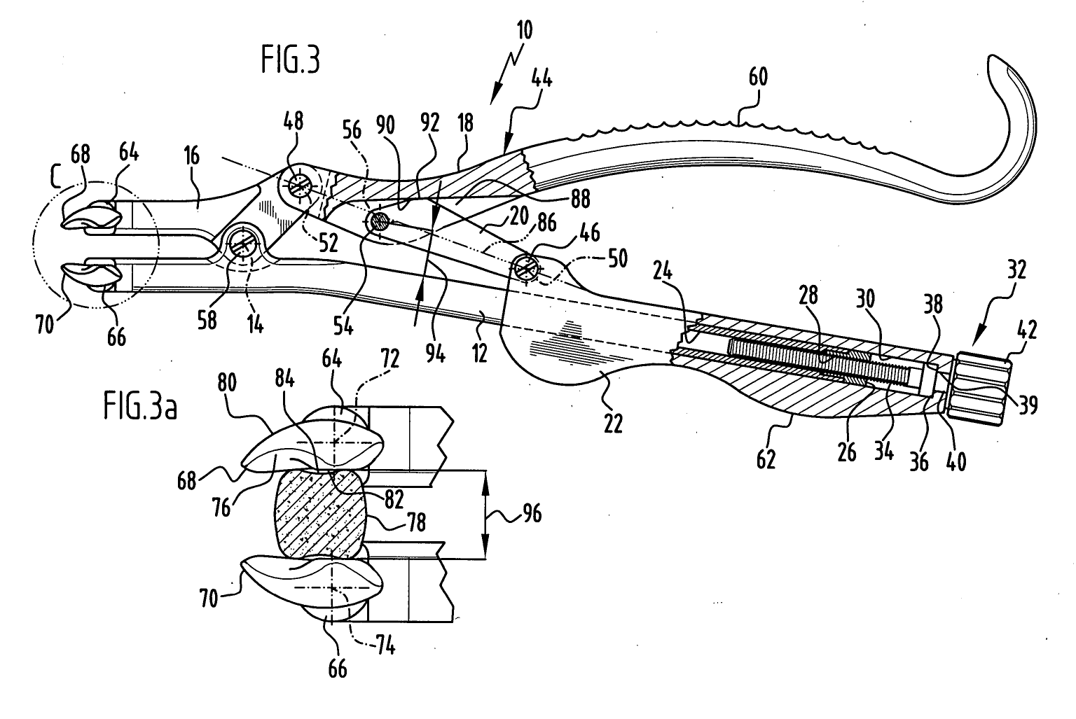

When the swivel grip 18 is swivelled further in the direction towards the swivel lever 12, the distance 94 of the joint swivel axis 56 from the swivel lever 12 decreases further and is thus smaller than the distance of the connecting line 86 from the swivel lever 12. This position is shown in FIGS. 3 and 3a. To prevent the joint swivel axis 56 from approaching the swivel lever 12 any further, the geometry of the connecting lever 20 is selected such that the inner side 90 of the swivel grip 18 strikes the edge 92 of the connecting lever 20. The edge 92 thus forms a stop for the swivel grip 18. The effect of this stop is that, after the joint swivel axis 56 has passed through the dead center position of the joint in FIG. 2, the two clamping jaws 68 and 70 do not move any further apart than desired. This means that in the extracting position shown in FIG. 3, which represents a position of the knee lever 44 beyond the dead center position thereof, the clamping jaws 68 and 70 can only be moved further apart when the swivel grip 18 is moved away from the swivel lever 12, namely by positively applying to the swivel grip 18 a force which points away from the swivel lever 12. In other words, however, this means that the tooth extraction forceps maintain the extracting position shown in FIG. 3, namely also when no holding force is swivelling the swivel grip 18 in the direction towards the swivel lever 12, as is, for example, required with the tooth extraction forceps known from DE 100 44 939 A1.

After clamping the tooth, the operator can grip and move the tooth extraction forceps in any chosen manner in order to lever the tooth out of the jawbone.

A second, preferred variant of the inventive method of extracting a tooth will be explained hereinbelow.

The tooth extraction forceps 10 shown in FIG. 1 are first transferred from the applying position shown in FIG. 1 to the extracting position shown in FIG. 3, namely without introducing the tooth 78 between the clamping jaws 68 and 70. The two clamping jaws 68 and 70 are then brought up to and over the tooth 78 by the operator, so that the clamping jaws 68 and 70 preferably do not touch the tooth 78, but, at any rate, do not receive it between them. By turning the rotary knob 42 in the closed extracting position of the extraction forceps 10 shown in FIG. 3, the operator now adjusts the distance 96 between the two clamping jaws 68 and 70 such that it is approximately 10 to 20% smaller than the diameter of the tooth 78. After carrying out this pre-adjustment, the operator opens the tooth extraction forceps, i.e., he transfers them from the extracting position shown in FIG. 3 back into the applying position shown in FIG. 1. The tooth extraction forceps 10 are now brought up to the tooth 78 in such a manner that the tooth 78 is introduced on both sides between the contacting surfaces 76 of the clamping jaws 68 and 70, as shown in FIG. 1a.

To fix the tooth extraction forceps 10 on the tooth 78, as already described in detail hereinabove, the swivel grip 18 is now moved in the direction towards the swivel lever 12, and the joint swivel axis 56 passes through the dead center position of the joint shown in FIGS. 2 and 2a and, finally, the inner side 90 of the swivel grip 18 strikes the edge 92 of the connecting lever 20, so that the tooth extraction forceps again assume the extracting position shown in FIG. 3, but now hold the tooth 78 clamped between the two clamping jaws 68 and 70.

With light movements sideways and without any excessive levering, the operator is now able to extract the tooth almost vertically with feeling. The tooth socket or the jaw is thus treated gently and traumatic secondary pain is avoided or at least minimized for the patient.

1. Method of extracting a tooth from the jawbone of a human being or an animal with a tooth extraction instrument, the tooth extraction instrument being able to be brought from an applying position in which the tooth extraction instrument may be applied to the tooth to be extracted into an extracting position in which the tooth extraction instrument is secured to the tooth to be extracted, comprising the steps:
applying and grasping the tooth extraction instrument assuming the approaching position to the tooth to be extracted,
fixing the tooth extraction instrument on the tooth to be extracted by transferring the tooth extraction instrument from the applying position to the extracting position, and
performing extracting movements with the tooth extraction instrument for levering out the tooth to be extracted.

2. Method in accordance with claim 1, wherein tooth extraction forceps are used as tooth extraction instrument, the tooth extraction forceps comprising two contacting elements for application to the tooth, the contacting elements being adjustable in their mutual spacing in a clamping direction by a handling device such that the contacting elements may be brought from the applying position into the extracting position.

3. Method in accordance with claim 2, wherein the spacing of the contacting elements from each other is adapted in rough approximation to the diameter of the tooth to be extracted prior to applying the tooth extraction instrument to the tooth to be extracted.

4. Method in accordance with claim 2, wherein the maximum spacing of the contacting elements in the applying position is adjusted such that at most it is 25% greater than the diameter of the tooth to be extracted prior to applying the tooth extraction instrument to the tooth to be extracted.

5. Method in accordance with claim 2, wherein the maximum spacing of the contacting elements in the applying position is adjusted such that it is approximately 10% to 25% greater than the diameter of the tooth to be extracted prior to applying the tooth extraction instrument to the tooth to be extracted.

6. Method in accordance with claim 3, wherein a minimum spacing of the contacting elements in the extracting position is adjusted such that it is smaller than the diameter of the tooth prior to applying the tooth extraction instrument to the tooth to be extracted, and wherein after adjusting the minimum spacing of the contacting elements, the tooth extraction instrument is transferred to the applying position.

7. Method in accordance with claim 6, wherein the tooth extraction instrument is brought up close to the tooth in the extracting position for adjustment of the spacing of the contacting elements.

8. Method in accordance with claim 6, wherein the minimum spacing of the contacting elements is adjusted such that it corresponds approximately to 0.8 to 0.9 times the diameter of the tooth to be extracted.

9. Method in accordance with claim 8, wherein the tooth extraction instrument is brought up close to the tooth in the extracting position for adjustment of the spacing of the contacting elements.

10. Method in accordance with claim 2, wherein the two contacting elements may be swivelled about a swivel axis relative to each other, and wherein the two contacting elements are swivelled about the swivel axis relative to each other for fixing the tooth extraction instrument on the tooth.

11. Method in accordance with claim 2, wherein one contacting element is supported via an articulated knee lever on the other contacting element, wherein the articulated knee lever comprises two parts mounted on each other for swivel movement about a joint swivel axis, and wherein one of the two contacting elements and one of the two parts of the knee lever carry grip elements via which they may be swivelled relative to each other.

12. Method in accordance with claim 11, wherein a distance of the joint swivel axis from the grip element of the other contacting element is smaller in the extracting position than in the applying position.

13. Method in accordance with claim 11, wherein the articulated knee lever is moved by swivelling the two grip elements relative to each other, during transition of the tooth extraction instrument from the applying position to the extracting position, through a dead center position of the joint in which a first supporting point associated with one contacting element, a second supporting point of the knee lever associated with the other contacting element, and the joint swivel axis lie on one line.

14. Method in accordance with claim 13, wherein the handling device is acted upon with an actuating force acting substantially parallel or opposite to the clamping direction in order to overcome the dead center position of the joint.

15. Method in accordance with claim 11, wherein a supporting point of the knee lever is adjustable at one end.

16. Method in accordance with claim 15, wherein a maximum spacing of the contacting elements in the applying position and/or a minimum spacing of the contacting elements in the extracting position is set by adjusting the supporting point of the knee lever.

17. Method in accordance with claim 15, wherein the supporting point of the knee lever is defined by a swivel mounting of the knee lever on a slide sleeve, and wherein the supporting point is adjusted by displacing the slide sleeve.

18. Method in accordance with claim 17, wherein the slide sleeve is displaced by means of a spindle drive associated with the slide sleeve.

19. Method in accordance with claim 2, wherein the tooth extraction instrument comprises an energy accumulator, and wherein the contacting elements are movable away from each other against the action of the energy accumulator.

20. Method in accordance with claim 6, wherein the tooth extraction instrument comprises an energy accumulator, and wherein the contacting elements are movable away from each other against the action of the energy accumulator.

21. Method in accordance with claim 7, wherein the tooth extraction instrument comprises an energy accumulator, and wherein the contacting elements are movable away from each other against the action of the energy accumulator.

22. Method in accordance with claim 21, wherein a supporting point of the knee lever is coupled with the energy accumulator such that the supporting point is movable against the action of the energy accumulater.

23. Method in accordance with claim 20, wherein the energy accumulator is arranged in the area between the swivel axis and at least one of the two contacting elements.

24. Method in accordance with claim 23, wherein the tooth extraction instrument comprises two clamping arms which include the contacting elements, and wherein at least one of the two clamping arms forms the energy accumulator by way of its inherent elasticity.

25. Method in accordance with claim 22, wherein the energy accumulator is formed by a spring supported on the grip element.

26. Method in accordance with claim 2, wherein the handling device comprises a stop, and wherein the handling device is actuated in such a manner during transfer of the tooth extraction instrument from the applying position to the extracting position until at least part of the handling device strikes the stop.

27. Method in accordance with claim 26, wherein the stop is arranged on the joint part of the articulated knee lever, which connects the two grip portions of the tooth extraction instrument.

28. Method in accordance with claim 13, wherein the handling device comprises a stop, and wherein the handling device is actuated in such a manner during transfer of the tooth extraction instrument from the applying position to the extracting position until at least part of the handling device strikes the stop.

29. Method in accordance with claim 28, wherein for transfer from the applying position to the extracting position, the handling device is actuated in such a manner that the articulated knee lever passes through the dead center position of the joint before the at least one part of the handling device strikes the stop in the extracting position.

30. Method in accordance with claim 2, wherein the tooth extraction instrument comprises at least one holder for one of the two contacting elements, and the at least one holder carries the said one of the two contacting elements.

31. Method in accordance with claim 10, wherein the tooth extraction instrument comprises at least one holder for one of the two contacting elements, and the at least one holder carries the said one of the two contacting elements.

32. Method in accordance with claim 30, wherein at least one of the two contacting elements is mounted on the holder for rotation about an axis of rotation arranged transversely to the clamping direction.

33. Method in accordance with claim 31, wherein at least one of the two contacting elements is mounted on the holder for rotation about an axis of rotation arranged transversely to the clamping direction.

34. Method in accordance with claim 33, wherein the swivel axis extends parallel to the axis of rotation of the at least one rotatable contacting element.

35. Method in accordance with claim 32, wherein at least one of the contacting elements comprises two contacting surfaces arranged adjacent each other on opposite sides of the axis of rotation and constructed so as to project in such a manner that upon application to the tooth, they place themselves substantially in the form of a point or substantially parallel to the axis of rotation in the form of a line on the tooth.

36. Method in accordance with claim 35, wherein the contacting element with the two adjacent contacting surfaces comprises in cross section two convex sections separated from each other by a recess.

37. Method in accordance with claim 36, wherein the recess is of arc-shaped construction and passes tangentially into the adjacent arc-shaped convex sections.

38. Method in accordance with claim 35, wherein the contacting surfaces extend in the direction of the axis of rotation parallel thereto.

39. Method in accordance with claim 35, wherein the contacting surfaces are inclined in the direction of the axis of rotation slightly away from the axis of rotation towards the free end of the contacting element.

40. Method in accordance with claim 35, wherein both contacting elements are mounted on their holders for rotation about parallel axes of rotation and comprise adjacent contacting surfaces which can be placed in the form of a point or in the form of a line on the tooth.

41. Method in accordance with claim 32, wherein the second contacting element comprises a single contacting surface which is constructed so as to project in such a manner that upon application to the tooth, it places itself substantially in the form of a point or substantially parallel to the axis of rotation of the first contacting element in the form of a line on the tooth.

42. Method in accordance with claim 32, wherein the contacting surface of at least one of the two contacting elements is inclined in the direction of the axis of rotation slightly in the direction towards the tooth.

43. Method in accordance with claim 2, wherein a contacting surface of at least one of the two contacting elements has a shape which is adapted to the tooth.

44. Method in accordance with claim 2, wherein the contacting element or contacting elements are mounted in the holder so as to be exchangeable.

45. Method in accordance with claim 44, wherein the contacting element or contacting elements are selected in accordance with the shape of the tooth to be extracted.

46. Method in accordance with claim 32, wherein contacting element stops are provided for limiting the rotational movement of the contacting element or contacting elements.

47. Method in accordance with claim 35, wherein the contacting surfaces are roughened.

48. Method in accordance with claim 35, wherein the contacting surfaces are coated with diamond dust.
